(19) United States
(12) Patent Application Publication
(10) Pub. No.: US 2010/0083630 A1
(43) Pub. Date: Apr. 8, 2010

(54) DISCHARGE CHUTE FOR A LAWN MOWER

(76) Inventors: Bengt Ahlund, Trollhattan (SE); Jörgen Johansson, Jonkoping (SE); Janarne Wetterheim, Jonkoping (SE)

Correspondence Address: MOORE & VAN ALLEN PLLC, P.O. BOX 13706, Research Triangle Park, NC, 27709, US

(21) Appl. No.: 12/594,412

(22) PCT Filed: Apr. 5, 2007
(86) PCT No.: PCT/SE2007/000327

§ 371 Date: Nov. 23, 2009

(51) Int. Cl. A01D 67/00

(52) U.S. Cl. 56/320.2

(57) ABSTRACT

A discharge chute for a lawn mower is provided, comprising a channel for channelling grass from a grass ejection opening of a lawn mower, wherein the channel comprises a trajectory following portion which is shaped and adapted to substantially follow a trajectory that the grass is given upon cutting. A lawn mower comprising such a discharge chute is also provided.

### TECHNICAL FIELD

The present document relates to a discharge chute for a lawn mower. In particular, the present document relates to a discharge chute as defined by the appended independent claims.

### BACKGROUND

Conventional lawn mowers comprise a chassis, an engine, a cutter, wheels and a handle.

In rotary blade mowers, the cutter is a rotating blade which, for security and grass collection reasons, is arranged under a cutting deck in the middle of the chassis.

The engine is arranged over the cutting blade to transmit the rotating movement of the engine shaft directly to the cutting blade. If the lawn mower is self-propelled, a transmission is arranged between the engine and a drive axle for the wheels.

Rotary blade lawn mowers may be one of three types, depending on the handling of the cuttings:

Mulching mowers cut cuttings very small and leave them on the lawn.

Discharging mowers eject the cuttings through an outlet opening of the cutting deck and discharge them on the lawn.

Collecting mowers collect the cuttings in a bag.

Mulching mowers have a closed cutting deck.

Discharging and collecting type mowers may comprise a discharge chute connectable to a grass ejection opening in the cutting deck, so as to channel the cuttings in a desired direction for discharge or collection.

The grass ejection opening may be arranged at the rear end of the cutting deck, or at the end of the cutting zone, which usually is at the right hand side of the cutting deck. In this latter case, the grass is ejected as soon as it has been cut off, which allows efficient filling of a collecting bag.

For stability reasons, collecting bags are usually arranged at the rear, and not at the side, of the lawn mower.

Some mowers may be operated in different modes and are thus a combination of the types mentioned above. To enable using the same discharge chute for collection and discharge function of the lawn mower, the grass may be discharged at the rear end of the lawn mower, instead of at the side, even if the grass ejection opening is arranged at the side of the cutting deck.

However, discharge chutes may clog due to grass sticking onto its walls and/or grass falling towards the bottom of the discharge chute or back towards the cutting deck.

This is a particular problem with discharge chutes leading the cuttings from a grass ejection opening at the end of the cutting zone, for discharge or collection at the rear end of the lawn mower, since the cuttings in such discharge chutes need to be transported through a relatively long channel.

### SUMMARY

In view of the above, it is an objective to solve or at least reduce the problems discussed above. In particular, an objective is to provide a discharge chute for a lawn mower which is less likely to clog, and which allows efficient filling of a grass collection container attachable thereto.

The present solution is based on the understanding that the kinetic energy possessed by the grass when it leaves the cutting deck needs to be preserved for as long as possible to prevent the grass from sticking to the walls or falling down to the bottom of the discharge chute and/or sliding back towards the cutting deck.

The present solution is also based on the understanding that the kinetic energy is best preserved by adapting the shape of the discharge chute to the trajectory that the grass is given upon cutting.

Moreover, experimental work has been carried out to determine the trajectory.

According to a first aspect of the present solution, there is provided a discharge chute for a lawn mower, comprising a channel for channelling grass from a grass ejection opening of a lawn mower cutting deck, wherein said channel comprises a trajectory following portion which is shaped and adapted to substantially follow a trajectory that the grass is given upon cutting.

By “discharge chute” is understood a channel for transporting grass from a grass ejection opening in a cutting deck, to an outlet opening of said channel, which may or may not be connected to a grass collection container, for discharge or collection at the rear end of the lawn mower.

This limits the loss of kinetic energy in the channel, and thus the risk of grass falling back towards the intake and/or blocking the channel.

It further reduces the risk of damp grass sticking to the channel wall.

If the discharge chute is connected to a grass collection container, this also allows the grass to reach further into the container, thus filling it from the back onwards, which increases packing ability and efficiency.

A channel inlet opening may be directly or indirectly connectable to the grass ejection opening of a lawn mower cutting deck.

The trajectory following portion may extend along a substantial part of the length of the channel.

The trajectory following portion may extend from an inlet opening of the channel.

The channel may be convex relative to a horizontal plane.

An upper surface of said trajectory following portion may be shaped to substantially follow the trajectory.

The upper surface may be curved to substantially follow the trajectory.

An angle of said upper surface, relative to a horizontal plane, at an inlet opening of the channel, may be at least about 55°.

The angle of said upper surface relative to a horizontal plane, at an inlet opening of the channel, may be at least about 60°.

The angle of said upper surface relative to a horizontal plane, at an inlet opening of the channel, may be at least about 65°.

The angle of said upper surface relative to a horizontal plane, at an inlet opening of the channel, may be at least about 70°.

The angle of said upper surface relative to a horizontal plane at an inlet opening of the channel, may be less than about 75°.

Experiments have shown that this may be suitable angles. It should however be noted that it is practical aspects that set an upper limit to the angle, and that the angle of the upper surface may be more than 75° if found suitable.

It should also be noted that the angle in question is an angle at an inlet opening, which angle is adapted to substantially follow a trajectory that the grass is given upon cutting. This angle is not to be confused with other angles at an inlet opening, for example in a front view of said discharge chute, which are not relevant for the trajectory following characteristics of the discharge chute.

By “angle at an inlet opening of the channel” is understood that the angle is an angle of an inner wall of the channel. It is also understood that this does not exclude the possibility of the inlet opening of the channel having a certain shape provided to enable fastening of said inlet opening to a grass ejection opening. Thus, the angle in question may be in proximity of the opening, and need not be directly at the opening.

The angle may be measured in a side view of said discharge chute.

By “horizontal plane” is understood the horizontal plane of the lawn mower, thus the plane in which the cutting blade rotates.

The discharge chute may further comprise a deflection portion for deflecting the grass from the trajectory.

The deflection portion may be necessary to limit the height and/or length of the discharge chute, while allowing the grass to be directed in a desired direction. It may thus allow a collecting bag to be placed at a practical height relative to the ground for convenient handling of the bag.

The deflection portion may extend from a portion of the channel, where the inclination of said upper surface relative to a horizontal plane is less than 50°.

The discharge chute may further comprise a lower collecting surface for directing grass at the bottom of said channel towards an outlet opening of said channel.

This further reduces the risk of grass clogging the discharge chute.

The lower collecting surface may extend towards an outlet opening of the discharge chute.

The lower collecting surface may be downwardly inclined towards the outlet opening of said discharge chute.

The lower collecting surface may be arranged substantially below the deflection portion.

A suitable placement of the collecting surface may be in proximity of the deflection portion, where the grass is deflected from its trajectory, and possibly may fall down towards the bottom of the discharge chute, where it may risk to clog the same.

The extent of the lower collecting surface in a projection on a horizontal plane may substantially correspond to the extent of the deflection portion in a projection on the horizontal plane.

The deflection portion may be shaped and adapted for guiding grass towards a predetermined collecting position.

This may be as far away from the outlet opening as possible.

The deflection portion may be upwardly inclined towards the outlet opening.

If the discharge chute is connected to a grass collection container, this allows the grass to reach further into the container, thus filling it from the back onwards, which increases packing ability and efficiency.

It also further reduces the loss of kinetic energy, and thus the risk of clogging.

The discharge chute may be adapted for connection to a grass collection container.

The discharge chute may be integrated with a grass collection container.

The inlet opening may be adapted for channelling grass from an ejection opening of a lawn mower cutting deck.

The ejection opening may be in the side, in the upside or in a portion abridging a side and upside of a lawn mower cutting deck.

According to a second aspect of the present solution a lawn mower is provided, comprising the discharge chute as described above.

The lawn mower may be a walk behind lawn mower.

The lawn mower may further comprise a grass collection container.

The lawn mower may comprise a grass ejection opening arranged on a cutting deck of said lawn mower.

The ejection opening may be in the side, in the upside or in a portion abridging a side and upside of a lawn mower casing such as a cutting deck.

### BRIEF DESCRIPTION OF THE DRAWINGS

The above, as well as additional objects, features and advantages of the present solution, will be better understood through the following illustrative and non-limiting detailed description of preferred embodiments of the present solution, with reference to the appended drawings, where the same reference numerals will be used for similar elements, wherein:

FIG. 1 is a schematic side view of a discharge chute mounted on a lawn mower and connected to a grass collection container.

FIG. 2 is a schematic detailed view of the discharge chute in FIG. 1.

### DETAILED DESCRIPTION OF EMBODIMENTS

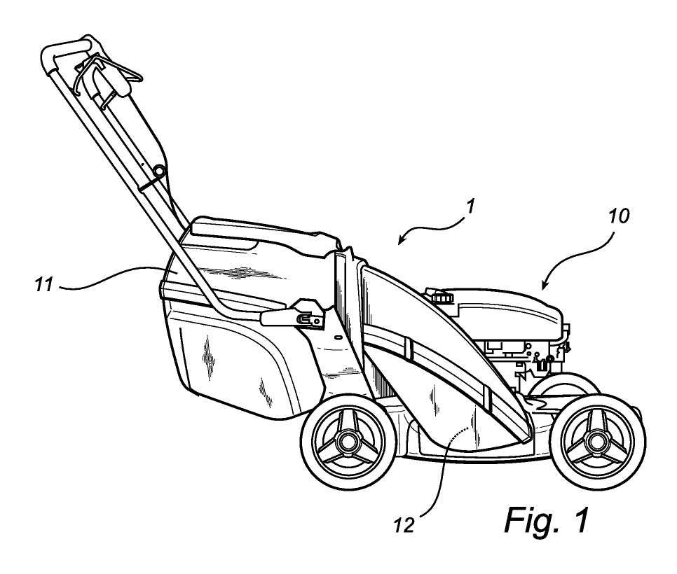

FIG. 1 shows a schematic side view of a lawn mower 10 that has a grass ejection opening 12 onto which a discharge chute 1 is mounted. The discharge chute 1 is further connected to a grass collection container 11. The grass ejection opening 12 of the lawn mower is provided at the end of a cutting zone at the right hand side of the lawn mower cutting deck, and abridges a portion of the side and the top of the cutting deck. The function of the discharge chute is to transport cuttings, which upon cutting are ejected from the grass ejection opening 12, through a channel inside the discharge chute to the grass collection container 11.

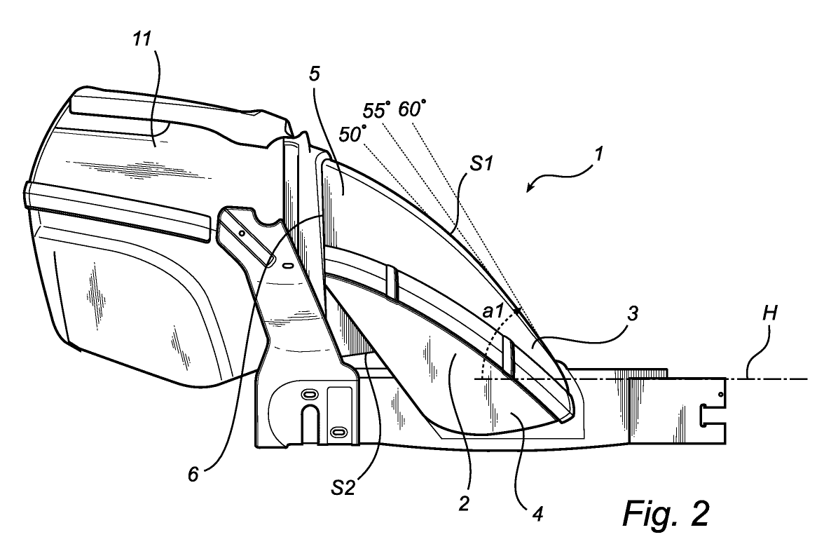

FIG. 2 shows, in more detail, a schematic side view of the discharge chute 1 as seen in FIG. 1. The channel 2 comprises a trajectory following portion 3 which is shaped and adapted for following a trajectory that the grass is given upon cutting, and a deflecting portion 5 which is arranged for deflecting the grass from said trajectory to direct it in a desired direction towards the back of the grass collecting container 11.

The upper surface S1 is shaped and adapted to follow the trajectory, by having an angle a1 at the inlet opening 4, which is 60° relative to a horizontal plane H. As indicated in FIG. 2, the surface S1 is curved so that its inclination relative to the horizontal plane H is successively reduced, giving the discharge chute a convex shape relative to the horizontal plane H.

The channel 2 further comprises a lower collecting surface S2 for preventing grass that has fallen towards the bottom of the channel from sliding back towards the inlet opening 4.

During operation of the lawn mower the grass is cut under the cutting deck and ejected at the end of the cutting zone through the grass ejection opening 12 of the cutting deck and into the inlet opening 4 of the discharge chute 1. Experiments have shown that the grass trajectory when leaving the cutting deck has an angle relative to a horizontal plane H of about 55°. Since the angle a1 of the upper surface S1 of the channel 2 at the inlet opening 4 of the channel 2 is 60°, and is gradually reduced to substantially follow the trajectory, the risk of cuttings hitting and/or sticking to the channel wall is reduced, as is the risk of clogging. Thus, the loss of kinetic energy in the cuttings is also reduced, which enables the grass flow to move swifter and more smoothly through the channel.

Cuttings which are deflected by the deflection portion 5 are directed towards the container for efficient filling of the same. Due to the deflection portion 5 being upwardly inclined relative to the horizontal plane H, the cuttings are directed towards the rear end of the grass collection container 11, thus filling it from the back onwards, which results in good packing efficiency.

Cuttings which fall down towards the bottom of the channel and hit the lower collecting surface are also directed towards the grass collection container 11.

The cutting deck and the discharge chute may be made of any suitable materials known in the art, such as for example steel sheet, plastic or cast aluminium alloys, or a combination thereof. The discharge chute and the cutting deck may or may not be made of the same material. The discharge chute, or a part thereof may form an integrated part of the cutting deck. For example, the cutting deck and the trajectory following portion of the discharge chute may be formed in one piece.

The solution has mainly been described above with reference to an embodiment. However, as is readily appreciated by a person skilled in the art, other embodiments than the one disclosed above are equally possible within the scope of the invention, as defined by the appended patent claims.

What is claimed is:

1. A discharge chute for a walk behind lawn mower, comprising:
a channel for channelling grass from a grass ejection opening of a lawn mower, wherein the channel comprises a trajectory following portion having an upper surface which is shaped to substantially follow a trajectory that the grass is given upon cutting, and wherein the upper surface is curved so that its inclination relative to a horizontal plane is successively reduced.

2. The discharge chute according claim 1, wherein the upper surface is curved to substantially follow the trajectory.

3. The discharge chute as claimed in claim 1, wherein an angle of said the upper surface relative to the horizontal plane, at an inlet opening of the channel, is at least about 55°.

4. The discharge chute as claimed in claim 3, wherein the angle of the upper surface relative to the horizontal plane, at an inlet opening of the channel, is at least about 60°.

5. The discharge chute as claimed in claim 4, wherein the angle of the upper surface relative to the horizontal plane, at an inlet opening of the channel, is at least about 65°.

6. The discharge chute as claimed in claim 5, wherein the angle of the upper surface relative to the horizontal plane, at an inlet opening of the channel, is at least about 70°.

7. The discharge chute as claimed in claim 1, wherein the angle of the upper surface relative to the horizontal plane at an inlet opening of the channel, is less than about 75°.

8. The discharge chute as claimed in claim 1, further comprising a deflection portion for deflecting the grass from the trajectory.

9. The discharge chute as claimed in claim 8, wherein the deflection portion extends from a portion of the upper surface where an angle of the portion of the upper surface relative to the horizontal plane is less than about 50°.

10. The discharge chute as claimed in claim 1, further comprising a lower collecting surface for directing grass at a bottom of the channel towards an outlet opening of the channel.

11. The discharge chute as claimed in claim 10, wherein the lower collecting surface is downwardly inclined towards the outlet opening of the channel.

12. The discharge chute as claimed in claim 10, wherein the lower collecting surface is arranged substantially below a deflection portion of the channel.

13. The discharge chute as claimed in claim 12, wherein an extent of the lower collecting surface in a projection on the horizontal plane substantially corresponds to an extent of the deflection portion in a projection on the horizontal plane.

14. The discharge chute as claimed in claim 8, wherein the deflection portion is shaped and adapted for guiding grass towards a predetermined collecting position.

15. The discharge chute as claimed in claim 8, wherein the deflection portion is upwardly inclined towards an outlet opening of the channel.

16. The discharge chute as claimed in claim 1, wherein the discharge chute is adapted for connection to a grass collection container.

17. The discharge chute as claimed in claim 1, wherein the discharge chute is integrated with a grass collection container.

18. The discharge chute as claimed in claim 1, wherein an inlet opening of the channel is adapted for channelling grass from a grass ejection opening of a lawn mower cutting deck.

19. A lawn mower comprising the discharge chute as of claim 1.

20. The lawn mower as claimed in claim 19, further comprising a grass collection container connected to the discharge chute.

21. The lawn mower as claimed in claim 19, further comprising a grass ejection opening arranged on a cutting deck of the lawn mower, wherein the grass ejection opening is adapted to channel grass into an inlet opening of the channel.
